(19) United States
(12) Patent Application Publication
(10) Pub. No.: US 2007/0062906 A1
(43) Pub. Date: Mar. 22, 2007

(54) Spill resistant closure

(76) Inventors: Emanuel P. Morano, Totowa, NJ (US); Robert F. Rosnak, Muskegon, MI (US); Jason Kay, Morristown, NJ (US); Joseph P. Sejnowski, North Kingstown, RI (US); Michael Cassiano Pereira, Smithfield, RI (US); William John Mussig, Seekonk, MA (US)

Correspondence Address: NOVARTIS;CORPORATE INTELLECTUAL PROPERTY, ONE HEALTH PLAZA 104/3, EAST HANOVER, NJ, 07936-1080, US

(21) Appl. No.: 11/511,844

(22) Filed: Aug. 29, 2006

Related U.S. Application Data
(60) Provisional application No. 60/713,032, filed on Aug. 31, 2005.
(60) Provisional application No. 60/811,238, filed on Jun. 6, 2006.

(51) Int. Cl. B65D 51/16; B65D 39/00; B67D 3/00; A47G 19/22

(52) U.S. Cl. 215/311; 215/387; 215/355; 222/525; 220/714; 220/717

(57) ABSTRACT

A valved closure for a liquid container is disclosed. The valved closure comprises a closure body having a base and a spout. A generally tubular insert is provided with an upper portion attached to the lower portion of the base. The insert body is sized to fit within a dispensing port of the liquid container and defines an insert passageway in fluid communication with the spout. The insert has at least one flexible flange extending outwardly therefrom for resiliently engaging the inner wall of the container and seal the closure to the container. A valve is retained between the insert and the closure body to operatively open and close the fluid passage through the closure from the container.

### CROSS REFERENCE TO RELATED APPLICATIONS

The present Application claims the benefit of U.S. Provisional Application 60/713,032, filed Aug. 31, 2005, and U.S. Provisional Application 60/811,238, filed Jun. 6, 2006.

### FIELD OF THE INVENTION

The present invention relates to the field of spill-resistant closures for liquid containers.

### BACKGROUND OF THE INVENTION

There are many spill resistant containers available. Examples of these include valved containers, such as sippy cups. Containers with valved closures are useful, but they require that material be added to them for use. For example, juice is poured from its storage container to the spill resistant container. This requires the step of transferring the liquid.

Containers are also available having a pop up type of valve, such as a water bottle or sports bottle. The valve is popped open to provide a flow path. The valve has to be pushed down to close the flow path. This requires action by a user to close the valve. If left open, the contents of a container could leak if tipped over. Pop up valves are usually provided on a cap with thread attachments so that they can connect to the threaded spout of the bottle. The problem with this is that there is no universal standard for threads for these types of bottles. One spout is not able to fit all types of bottles.

It would be desirable to provide a closure that could be fitted to different types of containers to provide a spill resistant valve.

### SUMMARY OF THE INVENTION

The present invention relates to the field of spill-resistant closures for liquid containers, and specifically to valved closures for liquid containers.

One aspect of the invention relates to a valved closure comprising a closure body having a base and a spout. The spout defines an upper passageway and a passageway is defined in a lower portion of the body. The closure also includes a container engagement portion preferably in the form of a generally tubular insert, and a valve, which is preferably retained between the insert and the closure body. An upper portion of the insert is secured to the lower portion of the base and restricts flow through the passageway. The insert is sized to fit within a dispensing port of a liquid container, such as a bottle, and defines an insert passageway on the opposite side of the valve from the upper passageway. At least one flexible flange extends radially from the insert body to engage the dispensing part and form a seal.

A further aspect of the invention includes a fluid dispensing apparatus comprising a fluid container and a closure body. The fluid container has an upper neck defining an interior surface. The closure body has a base, a container engagement portion and a flexible valve retained therebetween. The base includes a dispensing aperture disposed in a closure portion thereof. The engagement portion extends downwardly from the base. At least one resiliently flexible portion extends radially outwardly from the engagement. The engagement portion defines a lower passageway and has exterior dimension less than the interior dimension of the neck of the container. The flange is adapted to resiliently engage the interior of the neck of the container. The lower passageway is in fluid communication with the reservoir formed by the container, with the valve positioned between the lower passageway and the dispensing aperture.

### BRIEF DESCRIPTION OF THE DRAWINGS

FIG. 1 is a side elevational view of a valved closure according to a first embodiment of the present invention, as shown mounted on a bottle.

FIG. 1a is a partial side elevational view of a valved closure according to a further embodiment of the present invention, as shown on a bottle.

FIG. 2 is a cross-sectional view of a valved closure according to an embodiment of the present invention.

FIG. 3 is an exploded cross-sectional view of the valved closure embodiment of FIG. 2.

FIG. 4 is a cross-sectional view of the valved closure according to another embodiment of the present invention.

FIG. 5 is a cross-sectional view of the valved closure of the embodiment of FIG. 4, mounted on a bottle, as contemplated by FIG. 1.

FIG. 6 is a cross-sectional view of an embodiment of a portion of valved closure according to the present invention.

### DETAILED DESCRIPTION OF THE DRAWINGS

As used throughout, ranges are used as a shorthand for describing each and every value that is within the range. Any value within the range can be selected as the terminus of the range. When used, the phrase “at least one of” refers to the selection of any one member individually or any combination of the members. The conjunction “and” or “or” can be used in the list of members, but the “at least one of” phrase is the controlling language. For example, at least one of A, B, and C is shorthand for A alone, B alone, C alone, A and B, B and C, A and C, or A and B and C.

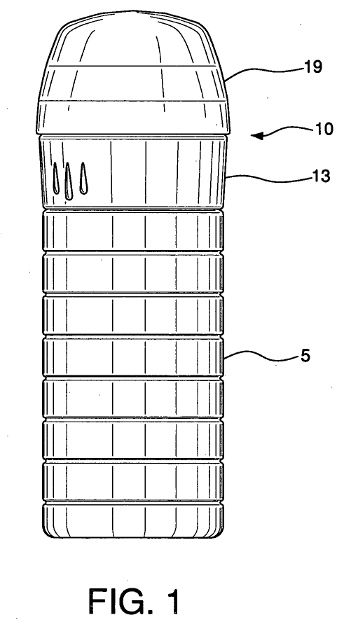

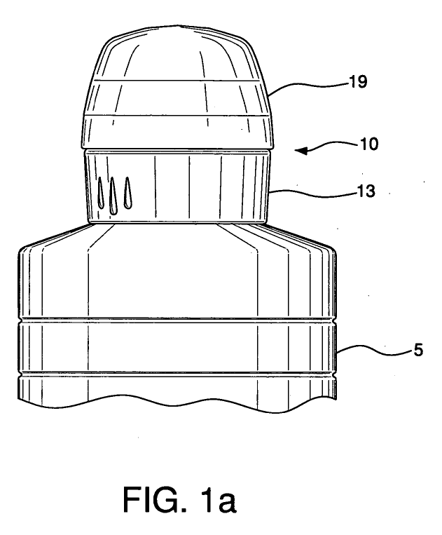

Referring to the figures, necked containers, such as the bottle (5) shown in FIG. 1, include a main reservoir or body and a narrow opening at one end (not shown in FIG. 1) Examples of necked containers for beverages include, but are not limited to, water bottles, soda pop bottles, juice bottles and sports bottles. These types of bottles are usually capped with a threaded closure. While many different manufacturers of bottles use a standard threading for their bottles, there is no universal standard for bottle threads. Although a necked container (5) is shown herein having a neck (6) (see, e.g., FIG. 5) that is significantly smaller than the outer dimension of the remainder of the container (5), the neck may be any size. The present invention preferably fits containers that have different size container openings.

The container can contain any type of liquid. In one embodiment, the liquid will be a beverage. Typical beverages include, water, juice, milk, soda pop, coffee, or tea. Other containers may contain liquids not meant for human consumption, including by way of example only, cleaning fluids, lubricants, soaps, and fragrances.

FIG. 1 shows an embodiment of the closure (10) fitted on a standard bottle (5). A skirt (13) engages the upper portion of the bottle (5), while a removable cap (19) covers the internal portions of the closure (10). As shown, the closure (10) has an exterior dimension substantially equal to that of the container (5). FIG. 1a shows an alternative embodiment of the closure (10), also fitted on a standard bottle. The outer dimension of the skirt portion (13) of the closure (10), is narrower than the outer dimension of the bottle. Both of these closure embodiments, as well those with other sizes, including some with dimensions larger than the exterior dimension of the container, may incorporate the features of the invention described below.

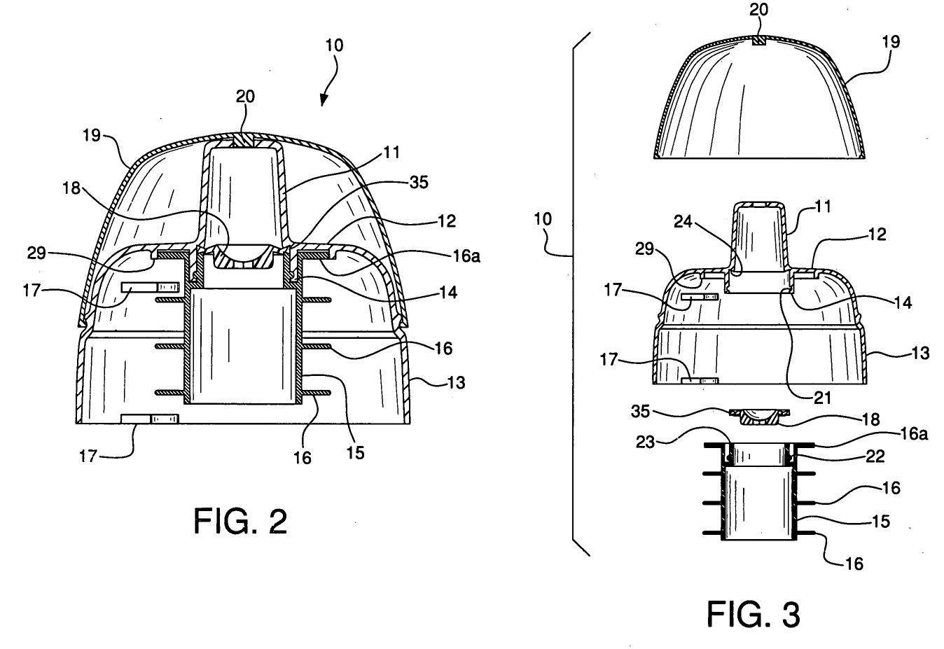

FIGS. 2 and 3 show an embodiment of a closure (10), including a spout (11) extending upwardly from a base (12). Extending downwardly from a perimeter of the base (12) is a skirt (13). On the under side of the base (12) is defined a lower portion (14), located radially inward from the skirt (13). A bottle insert or plug (15) is attached to the lower portion (14). A valve (18) is retained between the bottle insert (15) and the base (12). Alternatively, the valve (18) may be attached within the spout (11), to the lower portion (14), or within the bottle insert (15). The spout (11), the base (12) and the skirt (13) can be of unitary construction, or the parts can be separately formed and assembled.

The bottle insert (15) shown FIGS. 2 and 3 is snap attached to the lower portion (14) of the base (12). To facilitate the attachment, the lower portion (14) includes an annular groove (21) and the bottle insert (15) includes an annular ridge (22) sized to snugly fit within the annular groove (21). An upper portion (23) of the insert (15) has a generally “U” shaped groove and is sized to receive the annular projection of the lower portion (14). The ridge (22) is shown extending outwardly from an inner wall of the groove in the insert (23). However, the ridge (22) and groove (21) may be disposed on any surface.

The insert (15) is sized to fit inside the discharge part of a container. Preferably, the discharge part of the bottle is a cylindrical shape. The insert (15) has a main body and defines a lower flow path that extends therethough. Extending radially away from the main body is a plurality of flanges (16). The flanges (16) are preferably made of a resilient material, that will flex and provide resistance to the insertion of the insert (15) into the discharge part of a container, thereby allowing the closure (10) to be held in place and seal the port. The flanges (16) are preferably flexible enough to permit removal of the closure (10) by a gentle pull force. The flanges (16) also allow the closure (10) to be fitted to necked containers with different diameter openings by extending the effective diameter of the insert (15).

The insert (15) and flanges (16), pictured FIGS. 2 and 3, are of unitary construction. An uppermost flange (16a) preferably sits flushly against the base (12), around the lower portion (14). A retaining lip (29) extends downwardly from the base (12), engaging the peripheral edge of the uppermost flange (16a). The engagement between the base (12) and the uppermost flange (16a) may serve to form a part of the seal for the closure (10) and the container to prevent fluid leakage.

Typically, a container in the form of a bottle will include threads to retain a threaded cap (not shown). To assist in retaining the closure (10) on the container, retaining structures (17) that extend radially inward from the inside of the skirt (13) may be provided. The retainers (17) engage the threads on the container, a flange on the neck of the container, or the container sidewall. Alternatively, the retaining structure (17) may be positioned such that it acts as a stop for the insertion of the closure (10) when pushed onto the bottle. The retainer (17) can be located along the bottom side of the skirt (13) or at any point along the height of the skirt (13). More than one retaining structure (17) can be used. Also, the retaining structures (17) can be positioned in vertical relation to each other.

The retaining structures (17) can be a ring or a portion of a ring, such as a tab. Two ring portions can be positioned opposite each other on the skirt (13) adjacent the inside bottom edge. The skirt (13) can be made of a material that is flexible enough to deflect when it engages the neck or bottle wall. This facilitates removal of the closure from the container and allows the closure to adapt to different form and size containers.

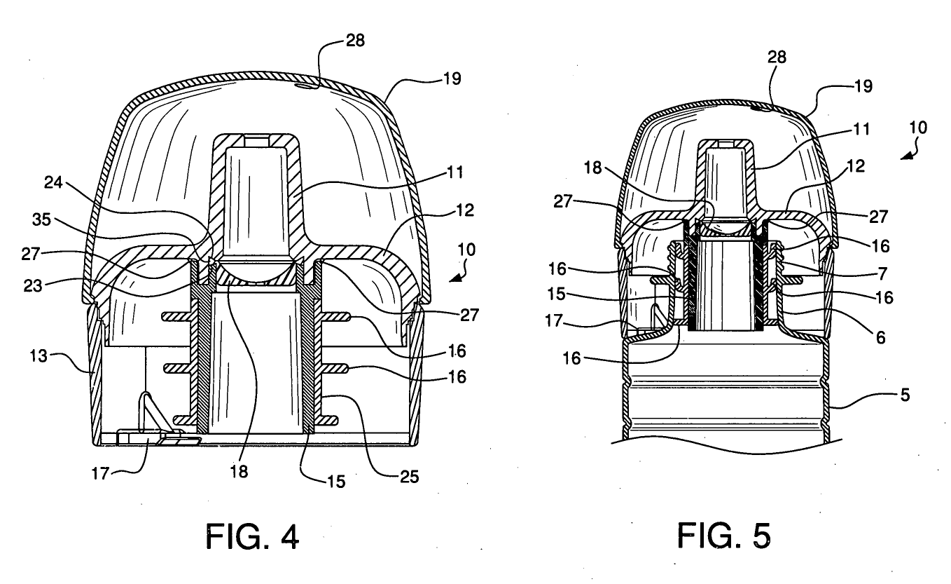

An alternate embodiment of a closure (10) is shown in FIGS. 4 and 5. Many of the features of the closure (10) are similar or identical to those in FIGS. 2 and 3. Namely, both closures include a base (12), with an upwardly extending spout (11) and a downwardly extending lower portion (14). An insert (15), having a generally “U” shaped channel on the insert portion (23), is adapted to engage the lower portion of the closure (10). The outer perimeter of the upper insert portion (23) in the present embodiment is preferably welded to the closure (10), using known techniques, such as ultrasonic welding. The weld (27) serves to retain the insert (15) to the closure (10) and seal the passageway between the insert (15) and the spout (11). Of course other forms of attachment may also be used, such as adhesives or a snap fit.

As shown in FIGS. 4 and 5, the flanges (16) on the insert (15) may separate the material from the insert body. The flanges (16) extend from a flange tube (25), that is secured to the outer surface of the insert (15). The flanges and tube (25) may be overmolded on to the insert. Other means of securing the insert (15) to the flanges (16) may also be used. The insert portion (15) is contemplated to be a relatively rigid material, while a more flexible, resilient material may be used for the flanges (16).

The valve (18) can be held in place by any desired structure. As illustrated, the valve (18) is attached directly to the underside of the spout (11), and secured by the attachment of the bottle insert (15). The valve may also be attached by direct molding of the valve in the spout tube, or by a snap fit structure. A ring having a generally triangular cross section may be formed between an upper portion (23) of the insert (15) and a lower portion (24) of the spout. The valve (18) has a peripheral flange (35) with a generally triangular cross section and is retained between the insert (15) and the closure (10).

The valve (18) is preferably made from a resiliently flexible material. Embodiments of the valve (18) include, but are not limited to planar valves, valves that are concave in the direction of flow, and valves that are convex in the direction of flow. These types of valves have an opening that operates in response to a change in pressure. The opening can be one or more slits that flex to open and close. Also, the opening may include one or more holes. These holes may be sized such that the surface tension of the liquid in the container is greater than the hydrostatic head pressure of the liquid. The surface tension keeps the liquid from flowing through the holes until a desired pressure differential is reached. When the closure is to be used with beverage containers, the valve material needs to be a food grade material. When used with other liquids, the valve is preferably made of a material that is inert to the liquid. Non-limiting examples of valve materials are silicone, polyethylene, and polypropylene.

In the embodiment shown, the valve (18) is convex in the direction of flow. Non-limiting examples of these types of valves are described in the following U.S. Pat. Nos. 5,213,236; 5,377,877; 5,339,955; 5,409,144; 5,439,143; and 5,890,621. Each of these patents are incorporated herein by reference. Such valves are available from Liquid Molding Systems of Midland, Mich. (LMS).

Resilient valves operate in response to a difference in pressure from each side of the valve (i.e. a pressure differential across the valve). The valve (18) can be designed such that it will not open until a desired pressure differential is achieved. The pressure differential can be achieved by increasing the pressure on one side of the valve (for example, by squeezing the container), can be achieved by decreasing the pressure (applying vacuum or suction) on one side of the valve (for example, by mouth suction on the spout), or can be achieved by a combination of the two. When the pressure differential is less than the desired pressure differential, the valve (18) will remain in its closed position. Preferably, the pressure differential needed for opening the valve is greater than the hydrostatic head pressure of the fluid contents in the container to which the closure is attached. This allows the container to be inverted without the fluid in the container exiting the container under its own weight.

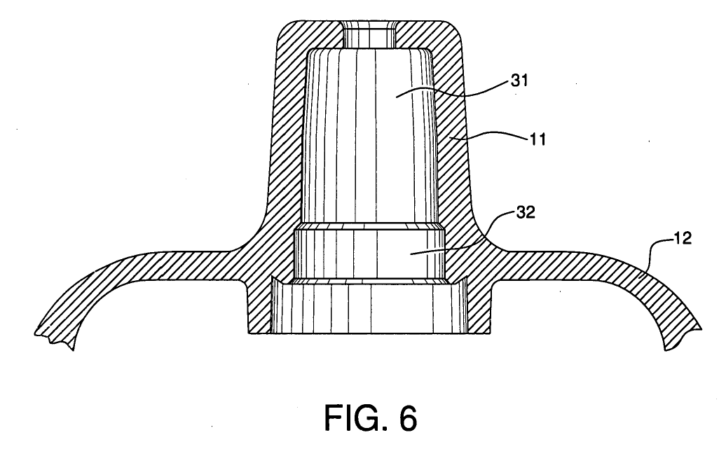

An embodiment of the base (12), seen in FIG. 6, may be used with any of the closures shown in FIGS. 1-5. The spout (11) is similar to that shown in the other embodiments. The lower portion of the passageway (31) is wider than the upper portion. The widened lower portion (32) facilitates the inversion of the valve without the valve body becoming engaged within the passageway (31). The extra space in the lower passageway (32) also facilitates the return of the valve to its original state (convex, toward the container).

The closure (10) of the various embodiments may include an overcap (19), which fits onto the closure (10) to removably cover the spout (11). This cover can help keep the spout (11) from becoming dirty during transport. The overcap (19) can snap onto the closure body (12) or can be attached using other structures, such as by a hinge, threads or otherwise.

The overcap (19) can optionally include a post (20), as seen in FIGS. 2 and 3, mounted on the underside. The post (20) is shown in FIG. 2 as inserted into the upper opening of the spout (11). This insertion can assist in centering the overcap (19) and provide additional attachment strength. The length of the post (20) can vary, and preferably just extends into the spout opening, such that it does not contact the valve (18). When the post (20) extends to the valve (18), the post (20) may assist in keeping the valve (18) closed by preventing flexing of the valve (18). The end of the post (20) can have any desired shape, flat or curved, and may conform to the curvature of the valve (18).

Referring now to FIGS. 4 and 5, the overcap (19) may also include a vent (28), which serves to allow air and moisture to-escape from under the cap (19).

The closure (10) can be made from any material that is between rigid and flexible. Examples of the material include, but are not limited to, polyethylene and polypropylene.

It should be appreciated that the present invention is not limited to the specific embodiments described above, but includes variations, modifications and equivalent embodiments defined by the following claims.

I claim:

1. A valved closure for a liquid container comprising:
a closure body having
a base, and
a spout extending upwardly from the base;
a tubular insert having
an upper portion attached to the lower portion of base, opposite the spout,
an insert body sized to fit within a dispensing port of the container, the insert body defining an insert passageway in fluid communication with the spout, and
at least one flexible flange extending radially from the insert body and adapted to engage the dispensing part of the container; and
a valve retained between the insert and the closure body serving to selectively open and close the flow path between the insert passageway and the spout.

2. The valved closure according to claim 1, wherein the insert is welded to the closure body.

3. The valved closure according to claim 1, wherein the upper insert portion is attached to the lower portion of the closure body by snap fit.

4. The valved closure according to claim 1, further comprising a skirt extending downwardly from a perimeter of the base, coaxially with the insert.

5. A valved closure for a liquid container comprising:
a closure body having
a base,
a spout defining an upper passageway and extending upwardly from the base, and
a lower portion extending from the away from the spout;
a container engagement portion extending downwardly from the lower and having
a generally cylindrical wall defining a passageway extending therethrough,
at least one resiliently flexible flange extending radially from the cylindrical wall and adapted to resiliently engage the liquid container; and
a valve disposed between the container engagement portion and the body.

6. The valved closure according to claim 5, further comprising a skirt extending downwardly from the base, radially outwardly of the lower portion.

7. The valved closure according to claim 5, wherein the container engagement portion is welded to the closure body.

8. The valved closure according to claim 5, wherein the container engagement portion is retained to the closure body by a mechanical engagement.

9. The valved closure according to claim 5, wherein the at least one resiliently flexible flange is overmolded on the generally cylindrical wall.

10. The valved closure according to claim 5, wherein the liquid container is a water bottle having a neck and the insert body is sized for compressive engagement with an interior portion of the water bottle neck.

11. The valved closure according to claim 5, the skirt further comprising a retaining means extending radially inwardly therefrom and adapted to restrict the movement of the valved closure away from the liquid container.

12. A fluid dispensing apparatus comprising
a fluid container having an upper neck defining an interior neck surface, having an interior dimension;
a closure body having
a base having a dispensing aperture disposed in a closure portion thereof, and
a container engagement portion extending from the base, away from the dispensing aperture, the container engagement portion having
an engagement wall defining a lower passageway and exterior dimension less than the interior dimension of the upper neck, and
at least one resiliently flexible flange extending radially from the engagement wall and adapted to flex toward the lower wall upon the application of compressive force; and
a flexible valve retained within the closure body between the lower passageway and the dispensing aperture;
the container engagement portion being resiliently retained within the upper neck of the bottle and the at least one flange flexed towards the lower wall.

13. The fluid dispensing apparatus according to claim 12, further comprising a skirt extending from an outer perimeter of the base towards the fluid container.

14. The fluid dispensing apparatus according to claim 12, wherein the engagement wall is welded to the closure body.

15. The fluid dispensing apparatus according to claim 12, wherein the engagement wall is retained to the closure body by a mechanical engagement.

16. The fluid dispensing apparatus according to claim 12, wherein the at least one resiliently flexible flange is overmolded on the engagement wall.
